(19) United States
(12) Patent Application Publication
(10) Pub. No.: US 2016/0291752 A1
(43) Pub. Date: Oct. 6, 2016

(54) ARRAY SUBSTRATE, TOUCH DISPLAY PANEL AND TOUCH DISPLAY DEVICE

(71) Applicants: Shanghai Tianma Micro-Electronics Co., Ltd., Shanghai (CN); Tianma Micro-Electronics Co., Ltd., Shenzhen (CN)

(72) Inventors: Jialing Li, Shanghai (CN); Conghua Ma, Shanghai (CN); Qijun Yao, Shanghai (CN)

(21) Appl. No.: 14/852,339

(22) Filed: Sep. 11, 2015

(30) Foreign Application Priority Data
Apr. 1, 2015 (CN) 201510152948.3

(51) Int. Cl. G06F 3/041

(52) U.S. Cl. CPC G06F 3/0412

(57) ABSTRACT

There are provided an array substrate, a touch display panel and a touch display device according to the disclosure. The array substrate includes: multiple gate lines and multiple data lines; multiple pixel units surrounded by the gate lines and the data lines; a common electrode layer divided into multiple electrode units, where each electrode unit includes at least two electrode blocks with a cross area where the at least two electrode blocks are chimeric with each other, the length of the cross area in a direction parallel to the data lines is greater than or equal to the length of an area where drive signals overlap in the direction parallel to the data lines, the area where the drive signals overlap includes the gate lines the drive signals for which overlap and the pixel units electronically connected to the gate lines.

### CROSS REFERENCE TO RELATED APPLICATIONS

The present application claims priority to Chinese Patent Application No. 201510152948.3, entitled “ARRAY SUBSTRATE, TOUCH DISPLAY PANEL AND TOUCH DISPLAY DEVICE”, filed on Apr. 1, 2015 with the State Intellectual Property Office of People's Republic of China, which is incorporated herein by reference in its entirety.

### FIELD OF INVENTION

The disclosure generally relates to the field of touch technique, and in particular to an array substrate, a touch display panel and a touch display device.

### BACKGROUND OF THE INVENTION

With the development of touch display integration technology, common electrodes of an array substrate of a display panel also function as touch electrodes. A touch drive and a display drive may be performed at different time duration in a time division mode, to implement a touch function and a display function with the same array substrate. In this way, the touch electrodes are integrated in the display panel, which reduces the fabrication cost, improves the efficiency and reduces the thickness of the panel.

Reference is made to FIG. 1, which is a schematic structural diagram of an array substrate of a touch display panel. The array substrate includes: multiple gate lines 11, multiple data lines 12 and a common electrode layer divided into multiple electrode blocks 13 insulated from each other and disposed as an array. As shown in FIG. 1, the gate lines 11 include a first gate line G1 to an n-th gate line Gn. The data lines 12 include a first data line S1 to an eighth data line S8. Each electrode block 13 is corresponding to multiple pixel units (not shown in FIG. 1). Each pixel unit is connected to one gate line 11 and one data line 12 adjacent to the pixel unit, for example, one pixel unit is connected to the first gate line G1 and the first data line S1.

Each of the gate lines 11 extends in a first direction X, and each of the data lines 12 extends in a second direction Y. The electrode blocks 13 are disposed above the gate lines 11 and the data lines 12, each electrode block 13 is corresponding to one electrode block trace (not shown in FIG. 1). Generally, a direction in which the electrode block traces extend is the same as the direction in which the data lines 12 extend. That is, the electrode block traces extend in the second direction Y. The electrode block traces is configured to: provide a common signal for the electrode block 13 when an image display is performed on the touch display panel where the array substrate locates; and provide a touch signal for the electrode block 13 when touch detection is performed on the touch display panel where the array substrate locates.

In order to ensure an image display effect under an unchanged frame frequency for image displaying, one original scanning period has to be divided into a touch stage and a display stage. In this way, scanning time for the display stage is shortened, that is, time during which respective pixel units are charged through the gate lines 11 is shortened. In order to ensure the charging time for each pixel unit, an overlap scanning mode is generally used in a gate drive circuit of the touch display panel. That is, a next gate line is precharged when the current gate line is scanned.

As shown in FIG. 2, when the gate lines are scanned one by one, for example the scanning is performed from the first gate line G1 to the n-th gate line Gn, the drive signals for adjacent gate lines overlap partially. The drive signal is input to an i-th gate line Gi at t1, the pixel unit electronically connected to the i-th gate line Gi starts to be charged, and the pixel unit electronically connected to the i-th gate line Gi finishes the charge at t3. In order to ensure the frame rate of the image display, an (i+1)-th gate line Gi+1 is precharged from t1 to t3. The drive signal is input to the (i+1)-th gate line Gi+1 at t2, the pixel unit electronically connected to the (i+1)-th gate line Gi+1 starts to be charged, and the pixel unit electronically connected to the (i+1)-th gate line Gi+1 finishes the charge at t4. Since the drive signals for adjacent gate lines overlap partly, coupling capacitance may formed between the gate lines 11 and the electrode blocks 13 or between the pixel electrodes. For each electrode block 13, the gate lines 11 may cause coupling effect on the common signal in the electrode block 13 in the overlap scanning mode.

Specifically, in the plurality of gate lines 11 corresponding to the same electrode block 13, the coupling effect caused by the gate lines 11 except the uppermost gate line 11 and the lowermost gate line 11 are consistent. For example, for the electrode block 13 in the first row and the first column in FIG. 1, both the coupling effect caused by the second gate line G2 and the coupling effect caused by the third gate line G3 act on the electrode block 13 in the first row and the first column However, the coupling effect caused by the fourth gate line

G4 and the fifth gate line G5 acts on the electrode block 13 in the second row and the second column

That is, the coupling effect caused by the gate line 11 (such as G4 and G5) at junction between different electrode blocks 13 is not consistent with the coupling effect caused by the gate line 11 (such as G2 and G3) in other region. Hence, a voltage of the electrode block 13 at the junction is different from the voltage of the electrode block 13 in other region, resulting in a problem that the display screen is unevenness at the junction between different electrode blocks 13 and stripes occur at the junction. The junction refers to the junction between two adjacent electrode blocks 13 in the second direction Y.

### SUMMARY OF THE INVENTION

In view of this, there are provided an array substrate, a touch display panel and a touch display device according to the disclosure, in order to solve the problem in the conventional art that the display screen is unevenness at the junction between different electrode blocks and stripes occur at the junction.

To achieve the above object, there are provided following technical solutions according to the disclosure.

An array substrate including multiple gate lines and multiple data lines; multiple pixel units surrounded by the gate lines and the data lines; a common electrode layer divided into multiple electrode units, where each of the electrode units includes at least two electrode blocks with a cross area where the at least two electrode blocks are chimeric with each other, a length of the cross area in a direction parallel to the data lines is greater than or equal to a length of an area where drive signals overlap in the direction parallel to the data lines, the area where the drive signals overlap includes the gate lines the drive signals for which overlap and the pixel units electronically connected to the gate lines.

A touch display panel including the above array substrate.

A touch display device including the above touch display panel.

Compared with the conventional art, the advantageous effects of the technical solutions according to the disclosure are as follows.

According to the array substrate, the touch display panel and the touch display device provided by the disclosure, the common electrode layer is divided into multiple electrode units, where each of the electrode units includes at least two electrode blocks with the cross area where the two electrode blocks are chimeric with each other, that is, an electrode shape corresponding to adjacent rows of the pixel units on two sides of the junction is changed into the electrodes shape with the cross area where the electrode blocks are chimeric, the length of the cross area in the direction parallel to the data lines is greater than or equal to the length of the area where drive signals overlap in the direction parallel to the data lines, the area where the drive signals overlap includes the gate lines the drive signals for which overlap and the pixel units electronically connected to the gate lines. In this way, a degree of coupling mutation at the junction between adjacent electrode blocks may be reduced, a degree of voltage change of the electrode blocks when thin film transistors of pixel units at the junction between adjacent electrode blocks may be reduced, thereby improving screen display effect.

### BRIEF DESCRIPTION OF THE DRAWINGS

Technical solutions of the embodiments of the present applicant and/or the prior art will be illustrated more clearly with the following brief description of the drawings. Apparently, the drawings referred in the following description constitute only a few of embodiments of the disclosure. Those skilled in the art may obtain some other drawings from these drawings without any creative work.

FIG. 1 is a schematic structural diagram of an array substrate of a touch display device in the conventional art;

FIG. 2 is a schematic diagram of drive signals for the array substrate shown in FIG. 1.

FIG. 3 is a schematic structural diagram of an array substrate according to an embodiment of the disclosure;

FIG. 4 is a schematic structural diagram of an array substrate according to another embodiment of the disclosure;

FIG. 5 is a schematic structural diagram of an array substrate according to another embodiment of the disclosure;

FIG. 6 is a schematic structural diagram of an array substrate according to another embodiment of the disclosure; and

FIG. 7 is a schematic structural diagram of an array substrate according to another embodiment of the disclosure.

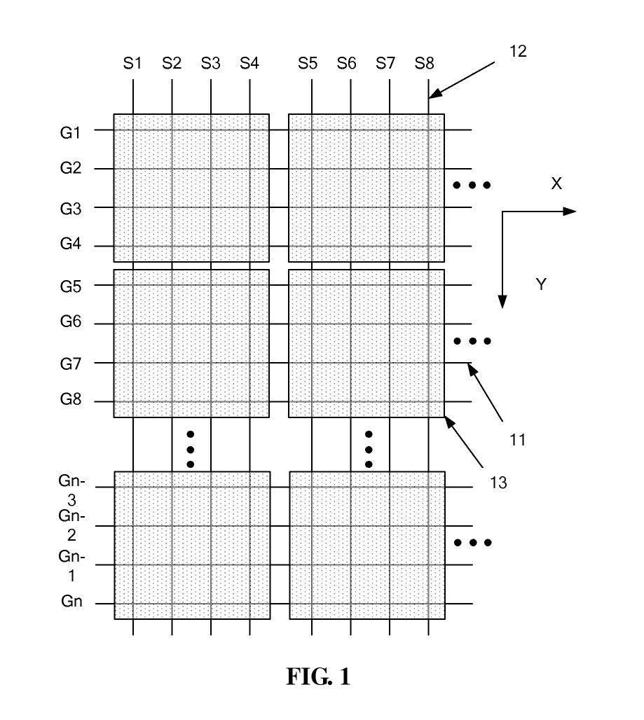

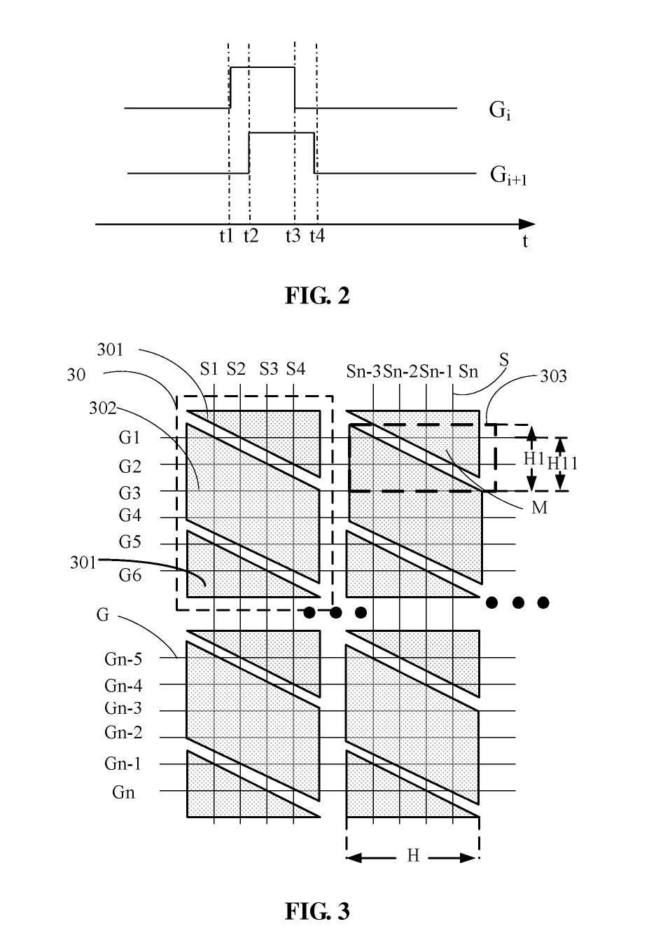

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

It is provided an array substrate according to an embodiment of the disclosure. The array substrate includes: multiple gate lines G1 to Gn, multiple data lines S1 to Sn, multiple pixel units surrounded by the gate lines G1 to Gn and the data lines S1 to Sn, a common electrode layer and a drive circuit. The common electrode layer is divided into multiple electrode units, where each electrode unit includes at least two electrode blocks with a cross area where the at least two electrode blocks are chimeric with each other. The length of the cross area in a direction parallel to the data lines is greater than or equal to the length of an area where drive signals overlap in the direction parallel to the data lines. The area where the drive signals overlap includes the gate lines the drive signals for which overlap and the pixel units electronically connected to the gate lines. The electrode blocks are electronically connected to the drive circuit through touch leads to serve as a touch electrode in a touch stage and as a common electrode in a display stage. Reference is made to FIG. 3 for the shapes of the electrode units and electrode blocks.

In this embodiment, as shown in FIG. 3, each of the electrode units 30 is rectangle and includes two first electrode blocks 301 and at least one second electrode block 302 between the two first electrode blocks 301. Further, in this embodiment, the shape of the first electrode block 301 is triangle, and the shape of the second electrode block 302 is parallelogram. The electrode blocks of the electrode unit 30 are disposed in the direction parallel to the data lines S. And the first electrode blocks 301 and the second electrode block 302 constitute the electrode unit 30.

As shown in FIG. 3, each first electrode block 301 or second electrode block 302 is corresponding to multiple gate lines G, multiple data lines S, and multiple pixel units M surrounded by the gate lines G and the data lines S. One grid surrounded by the gate lines G and the data lines S represents one pixel unit M, each pixel unit M is electronically connected to one gate line G and one data line S adjacent to the pixel unit M.

In this embodiment, the length of the cross area where the electrode blocks are chimeric, i.e., the cross area 303 where the first electrode block 301 and the second electrode block 302 are chimeric, in the direction parallel to the data lines S is greater than or equal to the length of the area where drive signals overlap in the direction parallel to the data lines S. The area where the drive signals overlap includes the gate lines G the drive signals for which overlap and the pixel units electronically connected to the gate lines G Since the area where the drive signals overlap generally includes two rows of the gate lines G and two rows of the pixel units M electronically connected to the two rows of the gate lines G, the length H1 of the cross area 303 where the first electrode block 301 and the second electrode block 302 are chimeric in the direction parallel to the data lines S is greater than or equal to the length H11 of two pixel units M in adjacent rows in the direction parallel to the data lines S.

The length H1 of the cross area 303 where the first electrode block 301 and the second electrode block 302 are chimeric in the direction parallel to the data lines S is less than or equal to half of the length H of the electrode unit 30 in a direction parallel to the gate lines G.

Since the gate line G1 and the gate line G2 in the cross area 303 are corresponding to both the first electrode block 301 and the second electrode block 302, the coupling effect caused by the gate line G1 and the gate line G2 acts on both the first electrode block 301 and the second electrode block 302. In this way, a degree of coupling mutation of the electrode blocks and the pixel electrodes at junction between adjacent electrode blocks may be reduced, a degree of voltage change of the electrode blocks when thin film transistors of pixel units at the junction between adjacent electrode blocks may be reduced, the problem that ripples occur at the junction between adjacent electrode blocks may be solved, thereby improving screen display effect.

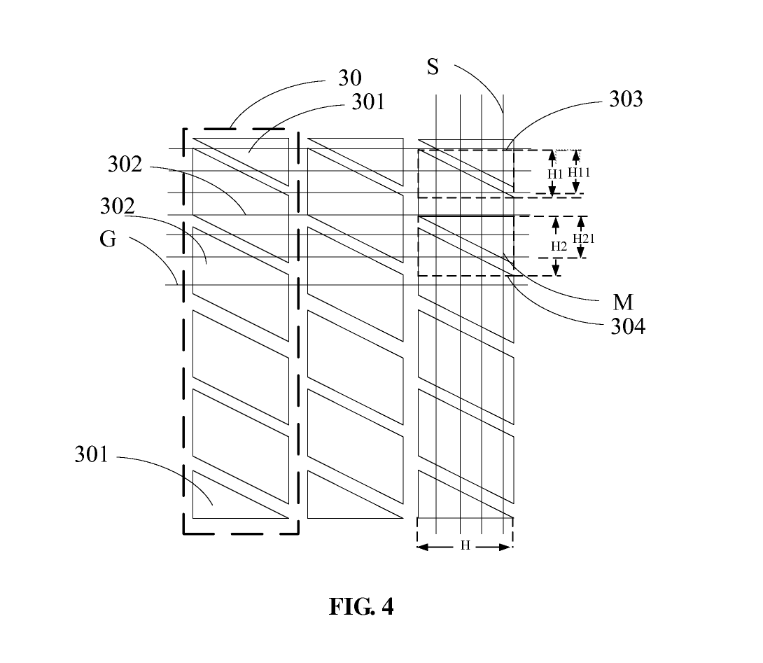

FIG. 3 is a schematic structural diagram of an array substrate in which the electrode unit 30 includes two first electrode blocks 301 and one second electrode block 302. In other embodiments of the disclosure, the electrode unit 30 may include two first electrode blocks 301 and multiple second electrode blocks 302 between the two first electrode blocks 301, as shown in FIG. 4.

In the embodiment shown in FIG. 4, the electrode unit 30 includes two first electrode blocks 301 and multiple second electrode blocks 302 between the two first electrode blocks 301. The shape of the first electrode block 301 is triangle, and the shape of the second electrode block 302 is parallelogram. Furthermore, in the embodiment, the length H1 of the cross area 303 where the first electrode block 301 and the second electrode block 302 are chimeric in the direction parallel to the data lines S is greater than or equal to the length H11 of two pixel units M in adjacent rows in the direction parallel to the data lines S, and is less than or equal to half of the length H of the electrode unit 30 in the direction parallel to the gate lines G.

The length H2 of the cross area 304 where the second electrode block 302 and the second electrode block 302 are chimeric in the direction parallel to the data lines S is greater than or equal to the length H21 of two pixel units M in adjacent rows in the direction parallel to the data lines S, and is less than or equal to half of the length H of the electrode unit 30 in the direction parallel to the gate lines G.

According to the array substrate provided by the embodiment, the common electrode layer is divided into the multiple electrode units, where each of the electrode units includes at least two electrode blocks with the cross area where the two electrode blocks are chimeric with each other, the length of the cross area in the direction parallel to the data lines is greater than or equal to the length of two pixel units in adjacent rows in the direction parallel to the data lines. In this way, a degree of coupling mutation of the electrode blocks and the pixel electrodes at the junction between adjacent electrode blocks may be reduced, a degree of voltage change of the electrode blocks when thin film transistors of pixel units at the junction between adjacent electrode blocks may be reduced, thereby improving screen display effect.

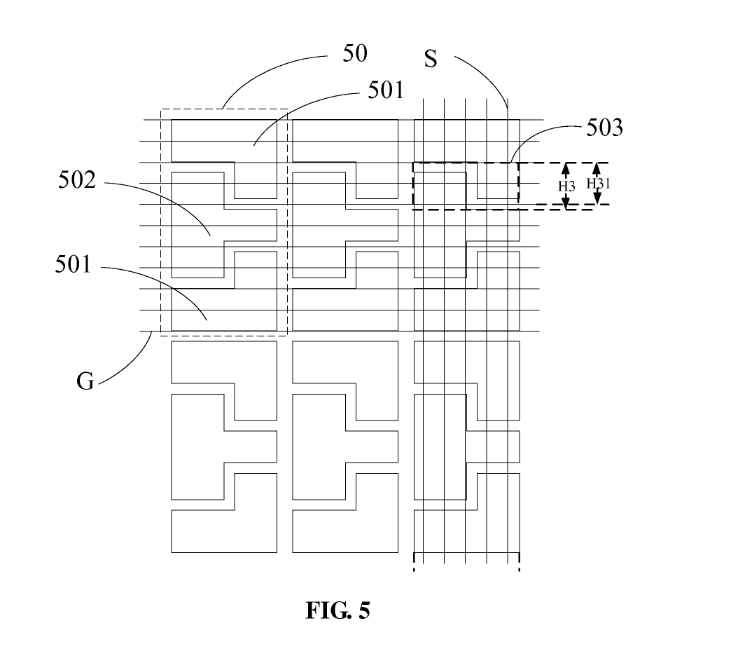

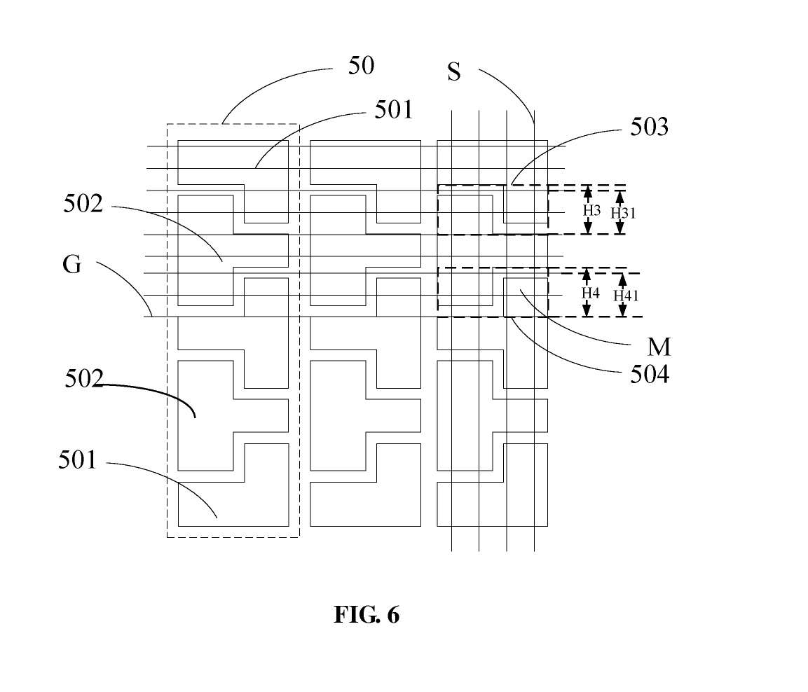

It is also provided an array substrate according to another embodiment of the disclosure, the structure of the array substrate according to this embodiment is substantially the same as the structure of the array substrate according to the above embodiment. The difference between the array substrate according to this embodiment and the array substrate according to the above embodiment lies in that the rectangle electrode unit 50 in this embodiment includes two first electrode blocks 501 of L-shaped and at least one second electrode block 502 of T-shaped between the two first electrode blocks 501 of L-shaped, as shown in FIG. 5 and FIG. 6.

As shown in FIG. 5, the length H3 of the cross area 503 where the first electrode block 501 and the second electrode block 502 are chimeric in the direction parallel to the data lines S is greater than or equal to the length H31 of two pixel units M in adjacent rows in the direction parallel to the data lines S, and is less than or equal to half of the length H of the electrode unit 50 in the direction parallel to the gate lines G.

In this embodiment, the electrode unit 50 may include two first electrode blocks 501 of L-shaped and one second electrode block 502 of T-shaped between the two first electrode blocks 501 of L-shaped, as shown in FIG. 5. Alternatively, the electrode unit 50 may include two first electrode blocks 501 of L-shaped and multiple second electrode blocks 502 of T-shaped between the two first electrode blocks 501 of L-shaped, as shown in FIG. 6.

As shown in FIG. 6, the electrode unit 50 includes two first electrode blocks 501 of L-shaped and multiple second electrode blocks 502 of T-shaped between the two first electrode blocks 501 of L-shaped. Furthermore, in this embodiment, the length H3 of the cross area 503 where the first electrode block 501 and the second electrode block 502 are chimeric in the direction parallel to the data lines S is greater than or equal to the length H31 of two pixel units M in adjacent rows in the direction parallel to the data lines S, and is less than or equal to half of the length H of the electrode unit 50 in the direction parallel to the gate lines G.

The length H4 of the cross area 504 where the second electrode block 502 and the second electrode block 502 are chimeric in the direction parallel to the data lines S is greater than or equal to the length H41 of two pixel units M in adjacent rows in the direction parallel to the data lines S, and is less than or equal to half of the length H of the electrode unit 50 in the direction parallel to the gate lines G.

According to the array substrate provided by this embodiment, the common electrode layer is divided into multiple electrode units, where each of the electrode units includes at least two electrode blocks with the cross area where the two electrode blocks are chimeric with each other, the length of the cross area in the direction parallel to the data lines is greater than or equal to the length of two pixel units in adjacent rows in the direction parallel to the data lines. In this way, a degree of coupling mutation of the electrode blocks and the pixel electrodes at the junction between adjacent electrode blocks may be reduced, a degree of voltage change of the electrode blocks when thin film transistors of pixel units at the junction between adjacent electrode blocks may be reduced, thereby improving screen display effect.

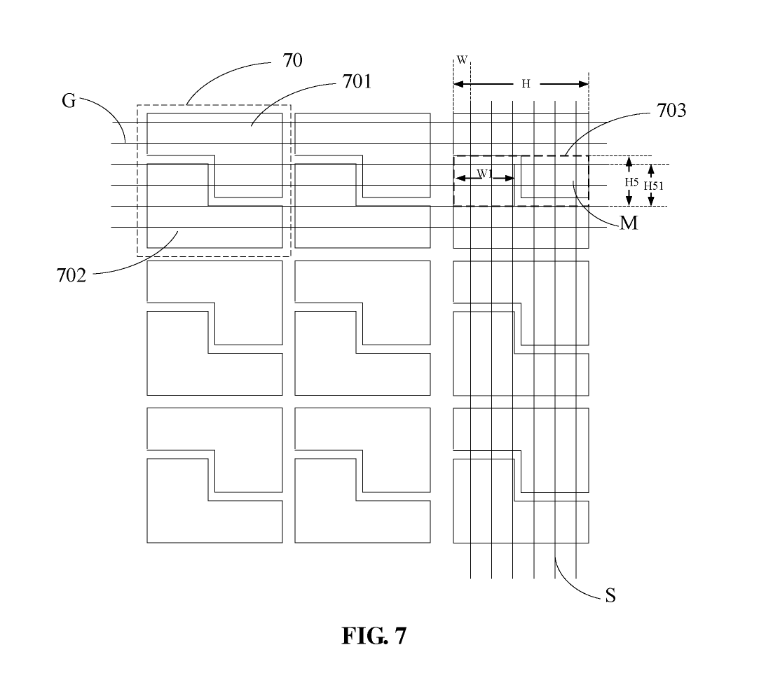

It is also provided an array substrate according to another embodiment of the disclosure, the structure of the array substrate according to this embodiment is substantially the same as the structure of the array substrate according to the above embodiment. The difference between the array substrate according to this embodiment and the array substrate according to the above embodiment lies in that the electrode unit 70 in this embodiment includes one first electrode block 701 of L-shaped and one second electrode block 702 of L-shaped disposed oppositely, and the first electrode block 701 and the second electrode block 702 constitute the rectangle electrode unit 70, as shown in FIG. 7.

The length H5 of the cross area 703 where the first electrode block 701 and the second electrode block 702 are chimeric in the direction parallel to the data lines S is greater than or equal to the length H51 of two pixel units M in adjacent rows in the direction parallel to the data lines S, and is less than or equal to half of the length H of the electrode unit 70 in the direction parallel to the gate lines G.

And the length W1 of the cross area 703 in the direction parallel to the gate lines G is greater than or equal to the length W of one column of the pixel units M in the direction parallel to the gate lines G and is less than or equal to half of the length H of the electrode unit 70 in the direction parallel to the gate lines G.

According to the array substrate provided by this embodiment, the common electrode layer is divided into multiple electrode units, where each of the electrode units includes at least two electrode blocks with the cross area where the two electrode blocks are chimeric with each other, the length of the cross area in the direction parallel to the data lines is greater than or equal to the length of two pixel units in adjacent rows in the direction parallel to the data lines. In this way, a degree of coupling mutation of the electrode blocks and the pixel electrodes at the junction between adjacent electrode blocks may be reduced, a degree of voltage change of the electrode blocks when thin film transistors of pixel units at the junction between adjacent electrode blocks may be reduced, thereby improving screen display effect.

It is also provided according to another embodiment of the disclosure a touch display panel including the array substrate according to any one of the above embodiments.

It is also provided according to another embodiment of the disclosure a touch display device including the above touch display panel.

The embodiments of the disclosure are described herein in a progressive manner, with an emphasis placed on explaining the difference between each embodiment and the other embodiments; hence, for the same or similar parts among the embodiments, they can be referred to from one another. The above description of the embodiments disclosed herein enables those skilled in the art to implement or use the disclosure. Numerous modifications to the embodiments will be apparent to those skilled in the art, and the general principle herein can be implemented in other embodiments without deviation from the spirit or scope of the disclosure. Therefore, the disclosure will not be limited to the embodiments described herein, but in accordance with the widest scope consistent with the principle and novel features disclosed herein.

1. An array substrate, comprising:
a plurality of gate lines and a plurality of data lines;
a plurality of pixel units surrounded by the gate lines and the data lines; and
a common electrode layer divided into a plurality of electrode units, wherein each of the electrode units comprises at least two electrode blocks with a cross area where the electrode blocks are chimeric with each other;
wherein a length of the cross area in a direction parallel to the data lines is greater than or equal to a length of an area where drive signals overlap in the direction parallel to the data lines;
wherein the area where the drive signals overlap comprises the gate lines the drive signals for which overlap and the pixel units electronically connected to the gate lines.

2. The array substrate according to claim 1, wherein the pixel units in a same row are electronically connected to a same gate line, the length of the cross area where the electrode blocks are chimeric in the direction parallel to the data lines is greater than or equal to the length of two pixel units in adjacent rows in the direction parallel to the data lines.

3. The array substrate according to claim 2, further comprising a drive circuit, wherein the electrode blocks are electronically connected to the drive circuit through touch leads to serve as a touch electrode in a touch stage and as a common electrode in a display stage.

4. The array substrate according to claim 2, wherein a shape of each of the electrode units is rectangle and comprises two first electrode blocks and at least one second electrode block between the two first electrode blocks, and the electrode blocks of the electrode unit are disposed in the direction parallel to the data lines.

5. The array substrate according to claim 2, wherein each electrode unit comprises two first electrode blocks and one second electrode block between the two first electrode blocks, or the electrode unit comprises two first electrode blocks and a plurality of second electrode blocks between the two first electrode blocks.

6. The array substrate according to claim 5, wherein the length of the cross area where the first electrode block and the second electrode block are chimeric in the direction parallel to the data lines is less than or equal to half of the length of the electrode unit in a direction parallel to the gate lines.

7. The array substrate according to claim 5, wherein a shape of the first electrode block is triangle, and a shape of the second electrode block is parallelogram.

8. The array substrate according to claim 5, wherein the first electrode block is L-shaped, and the second electrode block is T-shaped.

9. The array substrate according to claim 3, wherein a shape of each electrode unit is rectangle and comprises one first electrode block of L-shaped and one second electrode block of L-shaped disposed oppositely.

10. The array substrate according to claim 9, wherein the length of the cross area where the first electrode block and the second electrode block are chimeric in the direction parallel to the data lines is less than or equal to half of the length of the electrode unit in a direction parallel to the gate lines.

11. The array substrate according to claim 10, wherein the length of the cross area in the direction parallel to the gate lines is greater than or equal to the length of one column of the pixel units in the direction parallel to the gate lines and is less than or equal to half of the length of the electrode unit in the direction parallel to the gate lines.

12. A touch display panel comprising an array substrate, wherein the array substrate comprises:
a plurality of gate lines and a plurality of data lines;
a plurality of pixel units surrounded by the gate lines and the data lines; and
a common electrode layer divided into a plurality of electrode units, wherein each of the electrode units comprises at least two electrode blocks with a area where the electrode blocks are chimeric with each other;
wherein a length of the cross area in a direction parallel to the data lines is greater than or equal to a length of an area where drive signals overlap in the direction parallel to the data lines;
wherein the area where the drive signals overlap comprises the gate lines the drive signals for which overlap and the pixel units electronically connected to the gate lines.

13. A touch display device comprising a touch display panel, wherein the touch display panel comprises an array substrate comprising:
a plurality of gate lines and a plurality of data lines;
a plurality of pixel units surrounded by the gate lines and the data lines; and
a common electrode layer divided into a plurality of electrode units, wherein each of the electrode units comprises at least two electrode blocks with a cross area where the electrode blocks are chimeric with each other;
wherein a length of the cross area in a direction parallel to the data lines is greater than or equal to a length of an area where drive signals overlap in the direction parallel to the data lines;
wherein the area where the drive signals overlap comprises the gate lines the drive signals for which overlap and the pixel units electronically connected to the gate lines.
